(19) United States
(12) Patent Application Publication
(10) Pub. No.: US 2023/0120245 A1
(43) Pub. Date: Apr. 20, 2023

(54) AIR HANDLING UNIT COMPRISING FLOW GUIDING STATOR DISC

(71) Applicant: SWEGON OPERATIONS AB, Kvänum (SE)

(72) Inventor: Martin OTTERSTEN, Källby (SE)

(21) Appl. No.: 17/914,289

(22) PCT Filed: Mar. 24, 2021
(86) PCT No.: PCT/SE2021/050255

§ 371 Date: Sep. 23, 2022

(30) Foreign Application Priority Data
Mar. 24, 2020 (SE) 2050323-1

(51) Int. Cl. F24F 13/08; F24F 7/08

(52) U.S. Cl. CPC F24F 13/08; F24F 7/08

(57) ABSTRACT

An AHU includes air channels. The air channel includes an air inlet and outlet guiding supply air into a building from outside or extract air from a building to the outside. The AHU is connected to an air ventilation ducting system. The AHU further includes a fan inducing a flow in the system when connected thereto. The fan provides a radial flow or mixed flow. The flow from the fan is redirected from radial flow to axial flow on its way from the inlet to the outlet. To provide a more efficient flow when the air flow from the fan changes direction, the fan includes a stator ring. The stator ring has an inner circumference encircling the fan's back plate and a surface essentially levelled with the surface at the edge of the back plate. The AHU may also include a flow guiding body guiding the air further downstream.

### CROSS-REFERENCE TO RELATED APPLICATIONS

This application is the U.S. national phase of International Application No. PCT/SE2021/050255 filed Mar. 24, 2021 which designated the U.S. and claims priority to SE 2050323-1 filed Mar. 24, 2020, the entire contents of each of which are hereby incorporated by reference.

### BACKGROUND OF THE INVENTION

### Field of the Invention

The present invention relates to an Air Handling Unit (AHU) comprising a fan and a fan for an AHU. The fan is of the radial or mixed flow type.

### DESCRIPTION OF THE RELATED ART

Heating and Ventilating Air Conditioning (HVAC) systems are generally installed in buildings today when a new building is constructed or an old building is renovated. A HVAC system generally includes an Air handling Unit (AHU) for intake and discharge of air to and from the building. An AHU is often provided with a heat exchanger arrangement such that the extract air is heat exchanged with the supply air. In recent years, there has been an increased focus on lowering the energy consumption for HVAC systems and demand controlled ventilation (DCV) systems are frequently installed in new and renovated buildings in order to reduce the energy consumption. DCV systems generally include a multitude of sensors in order to provide relevant information for deciding a ventilation demand. Such sensors may for example detect occupancy in a room, air quality, temperature, predicted usage of a room and weather forecasts. The information from the sensors are used as input data in a control unit which uses the collected data, possibly together with user input data such as desired temperature, in order to control the HVAC system. A problem in these kinds of ventilation equipment (as well as older equipment) is that the AHU and the fan generate noise. In order to reduce the level of noise generated different solutions have been provided. In DE 44 22 519 is described how a fan and AHU may be designed in order to reduce the level of noise. DE 44 22 519 discloses how sound absorbing material have been provided in the AHU and the air ducts. The sound absorbing material will thus absorb noise arising from vibrations in the AHU. However, even though the arrangement in DE 44 22 519 discloses an arrangement which reduces the noise level, there is still a desire for a further reduction of noise produced in the fan and AHU.

### SUMMARY OF THE INVENTION

The object of the present invention is to provide an improved Air Handling Unit (AHU) for a Heating and Ventilating Air Conditioning (HVAC) system with a reduced level of noise generated in the fan and AHU. In particular, the invention is directed to provide an improved fan arrangement to be used in the AHU. AHUs used in HAVC systems for offices and other larger premises generally comprise a fan in order to create a flow. In case the fan is located in the fresh air intake for providing supply air to the building it will provide a supply air flow and build up an overpressure in the supply air ventilation ducts. The fan or fans comprised in the AHU are generally of the radial flow type in order to provide for a flow rate and pressure while avoiding the overall size of the fan and AHU to be too large. Concerning noise, there may be noise produced for low volume flows as well as for high volume flows thus corresponding to low and high speeds of the fan. In many cases, the noise problem may occur in particular at certain speeds of the fan (rpm) being multiples of the rpm where resonance occurs while a lower noise level may be found at rpm in the middle between these noise peaks. As discussed above, it was earlier more frequently used to have a number of fixed rpm, corresponding to certain airflow being “small”, “medium” and “large” air volume flows, while today it is desired to provide a step less control of the air fan speed and being able to provide any desired rpm. By the use of a step less control the fan and AHU may thus not be controlled to only run at “low noise” rpm and there is thus a stronger urge to provide an AHU and fan arrangement being able to reduce the noise at all rpm.

The invention thus relates to an Air Handling Unit (AHU) for providing air to a Heating and ventilating Air Conditioning (HVAC) system. The AHU is provided with an extract air channel comprising at least one extract air inlet for guiding extract air from a building to the outside through at least one extract air outlet and/or a supply air channel comprising at least one supply air inlet for guiding supply air from the outdoor into a building through at least one supply air outlet adapted to be connected to an air ventilation ducting system. The AHU further comprises at least one fan in order to induce a flow in the air ventilation ducting system when connected. The fan includes a front disc, a back plate and a plurality of fan blades located between the front disc and the back plate and the fan being designed such that said front disc has a hole where through air enters and said fan blades being arranged to provide a radial flow or mixed flow from the fan.

In order to improve the efficiency and reduce the noise level from the fan, the fan is designed to further comprise a stator ring having an inner circumference adapted to encircle said back plate and having a surface essentially levelled with the surface at the edge of the back plate. This arrangement will reduce the recirculation and the turbulence downstream of the fan, which reduce the noise level and energy losses.

The stator ring is bent backwards so as to form a curved surface being bent in the radial direction, i.e. bent to follow the direction of the flow of air through the fan and further through the AHU so as to provide a flow guide for the radial flow from the fan when the air flow deflects and change direction from being a mainly radial flow to a mainly axial flow.

The surface of the stator ring is bent at least 20 degrees, preferably at least 45 degrees and most preferably at least 90 degrees between its inner circumference, where the stator ring is levelled with back plate, and an outer circumference where the flow has been deflected. Hence, the design of the stator ring as described herein is made to have its surface close to the back plate essentially parallel to the surface of the back plate and being bent around 90 degrees to form a flow guiding surface adapted to guide the flow. Another way of describing the surface of the stator ring is to describe the surface of the stator ring to form a plane essentially perpendicular to the axial direction, i.e. perpendicular to the rotational axis of the fan, at the surface closest to the back plate where after the surface is bent and curved so as to form a surface reminding of the envelope surface of a cylinder or the surface of cone.

The stator ring could be designed to form part of a body extending backwards in the axial direction. The shape could be designed to remind of a drop shaped element having a hole at its rounded end which is fitted to the shape of the back plate and forms a smooth transition from the back plate surface to the surface of the body forming the stator ring.

The stator ring and body could also be separate parts and designed such that the stator ring could be designed to interact with a body extending backwards in the axial direction and adapted to fit in with the outer edge of the stator ring to form a common body.

The stator ring and body could be designed to extend backwards in the radial direction at least a distance L corresponding to the radius of the back plate or even more preferably at least the double distance of the radius of the back plate. The distance L is measured from the back plate.

The body extending backwards from the back plate could be designed to have a circumference of a cross sectional area in a plane perpendicular to the rotational axis (A) of the fan being larger than the circumference of the back plate. The circumference could be measured at a length corresponding to at least half the length of the extension of the body along the rotational axis A of the fan.

The stator ring and body could be designed to define an essentially continuous surface enclosing a space stretching from the edge of the back plate and backwards in the axial direction.

The body could be designed to have a shape of its outer surface reminding of a semi-spherical shape or truncated cone. It could also be designed to essentially remind of a truncated cone and having an opening at one end for fitting into the back plate and having a somewhat smoothly curved interconnection between the envelope surface and the circular end portions.

The stator ring and the body forming the flow guide may thus have different shapes which may work in order to provide a flow guide. The basic idea is to provide a surface which will be smooth and form a guiding surface which aids in achieving a desired flow with less noise and energy losses due to forming a wall along which the air from the fan may flow.

Further details of the stator ring and embodiments of the AHU will be described below in the detailed description.

### BRIEF DESCRIPTION OF THE DRAWINGS

The present invention will now be described more in detail with reference to the appended drawings, where:

FIGS. 1a-1c illustrate different Air Handling Units,

FIGS. 2a and 2b illustrates views of a radial fan,

FIGS. 3a-3c illustrate a radial fan in an Air Handling Unit, and

FIGS. 4a-4g illustrate different flow guiding arrangements.

### DESCRIPTION OF THE PREFERRED EMBODIMENTS

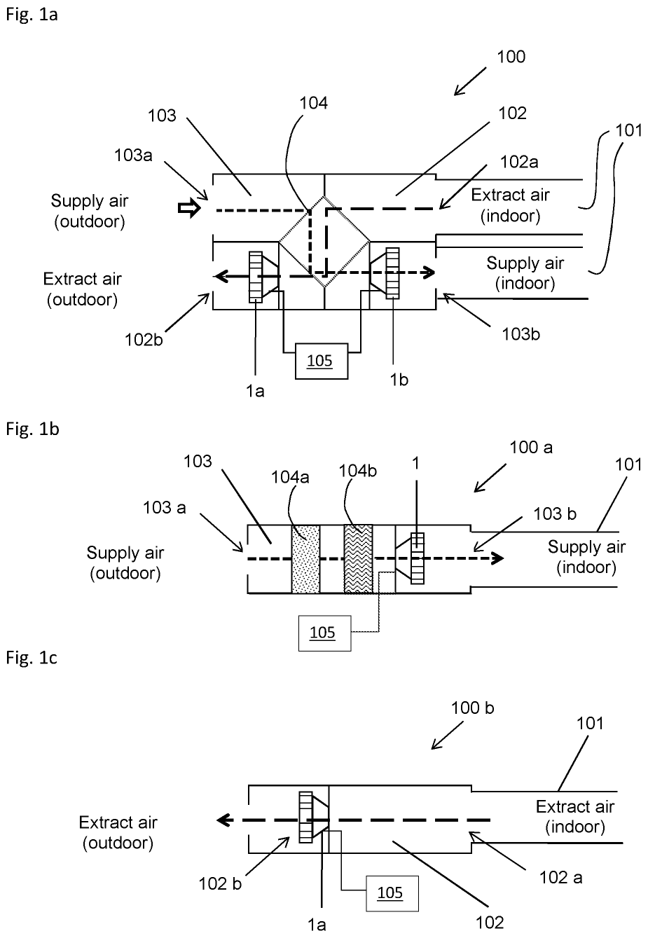

In FIG. 1 are disclosed different embodiments of an Air Handling Unit (AHU) 100 suitable for the present invention. In FIG. 1a is disclosed an AHU 100 connected to an air ventilation ducting system 101 comprising an extract air channel 102 and a supply air channel 103. The extract air channel 102 comprises an extract air inlet 102a connected to the air ventilation ducting system 101 for exhausting air from a building via an extract air outlet 102b for discarding extract air to the environment. The supply air channel 103 comprises supply air inlet 103a for inlet of fresh air from the environment and a supply air outlet 103b for guiding fresh air to the air ventilation ducting system to be distributed via the air ducting system 101 to a building. The extract air channel 102 and the supply air channel 103 are in a heat exchanging relation via a heat exchanger 104 in order to exchange heat between the extract air and the supply air. The extract air channel 102 is provided with an extract air fan 1a in order to induce a flow of extract air from a building via the air ventilation ducting system 101 and the supply air channel 103 is provided with a supply air fan 1b for inducing a flow of fresh air in the supply air channel 103 in order to distribute supply air to the building via the air ventilation ducting system. The AHU 100 is also connected to an Electronic Control Unit (ECU) 105 for control of the fans 1a, 1b.

The design of the AHU 100 in FIG. 1a is only schematically disclosing how an AHU comprising a pair of fans 1a, 1b according to the invention may be designed. The AHU 100 may include further devices such as dampers for controlling the flow, additional air treatment units, e.g. humidifiers, filters or additional heat regulating devices such as a heat pump or electrical heaters, as well as sensors for sensing relevant parameters concerning air quality and temperature of the air.

In FIG. 1b is disclosed another example of an AHU 100a suitable for the present invention which is of the single direction (SD) kind. An AHU of the SD kind only provides flow of air in one direction and this AHU 100 comprises a supply air channel 103 but no extract air channel. The AHU 100a is designed to only provide a flow of fresh air entering through a supply air inlet 103a to the AHU 100a and to be further guided via a supply air outlet 103b to an air ventilating ducting system 101 in order to distribute fresh air to a building. The AHU is further provided with a fan 1 in order to induce a flow of fresh air in the air ventilating ducting system. The AHU 100a is also provided with filter 104a in order to clean the supply air and a temperature conditioning unit 104b in order to adjust the temperature of the supply air stream.

In FIG. 1c is disclosed still another example of an AHU 100a suitable for the present invention. This AHU 100b is only of the SD kind comprises an extract air channel 102 but no supply air channel. The AHU 100b is thus designed to only provide a flow of extract air from a building. The extract air is guided from the air ventilating ducting system 101 to the AHU 100b via an extract air inlet 102a guided through the AHU 100 to a supply air outlet 102b to the environment. The AHU 100b is further provided with a fan 1 in order to induce a flow of extract air in the air ventilating ducting system 101. The AHU 100 in FIG. 1c does not include any air treatment units but could of course be provided with additional devices, e.g. some kind of heat recovery arrangement in order to regain heat from the air exhausted. For example, in case there is a single direction (SD) AHU present in a building for guiding extract air out of a building to the environment, as disclosed in FIG. 1c, there is also often present a supply air single direction AHU as disclosed in FIG. 1b. Hence, the AHU 100a in FIG. 1b and the AHU 100b in FIG. 1c may both comprise heat pumps connected between them such that heat is transferred between the supply air stream of the AHU 100a in FIG. 1b and the extract air stream of the AHU 100b in FIG. 1c.

Hence, the above figures only serves as a few examples from a multitude of different kinds of AHUs which may suitably be used for a fan 1, 1a, 1b as will be described below.

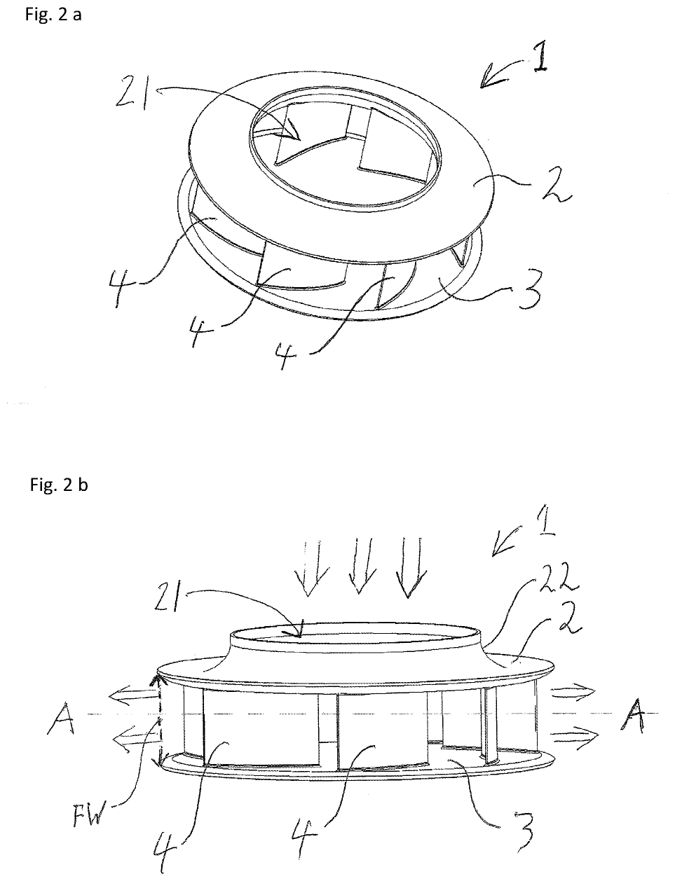

In FIG. 2 is disclosed a fan 1 for radial flow. In FIG. 2a is disclosed an isometric view of the fan 1 comprising a front disc 2, a back plate 3 and a multitude of fan blades 4 interposed between the front disc 2 and the back plate 3. In this case are the front disc 2, back plate 3 and the fan blades 4 produced as separate units which are assembled together by attaching the fan blades 4 to the front disc 2 and back plate 3 by any suitable means, e.g. by welding or by through going pins. However, the fan could also be moulded as a single piece. In the centre of the front disc 2 is provided an opening or hole 21 through which air may enter into the fan.

The flow of air through the fan 1 is disclosed in FIG. 2b which is a side view of the fan 1. FIG. 2b discloses how an axial flow of air is formed when air is sucked in through the central hole 21 in the front disc 2 when the fan is operating. The suction force is created by the fan blades 4 designed to provide a radial flow from the rotating fan 1. The blades 4 of the fan 1 is thus designed to produce a radial flow of air and together with the back plate 3 and front disc 2, which are functioning as guides, redirecting the axial air flow entering through the hole 21 in the front disc 2 to provide an induced radial flow when the fan 1 is operating. In FIG. 2b is also shown how the front discs 2 is provided with a curved opening 22 in order to improve the aerodynamics of the fan 1 for redirecting the air flow entering through the hole 21.

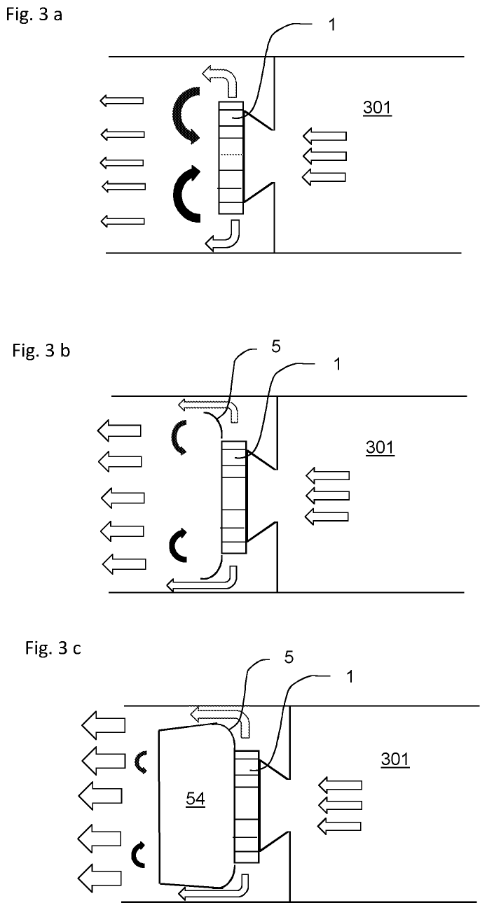

In FIG. 3a is disclosed a radial fan 1 in an air channel 301 in an Air Handling Unit (not shown). The air channel may for example be an extract air channel 102 or supply air channel 103 as disclosed in FIG. 2. The arrows indicate the flow of air through the air channel 301. The unfilled arrows (white arrows) indicate the main air flow in the air channel 301 as air passes through the fan 1. The filled arrows (black arrows) indicate deviations from the desired flow path of the air in the air channel 103. This flow will arise when air of high velocity leaves the radial fan 1, the air outside this high velocity flow stream will start to recirculate and develop turbulence behind the fan 1. These recirculating regions will cause an overall reduction of the efficiency of the fan as well as a risk for increased noise level.

In FIG. 3b is disclosed a radial fan 1 which has been provided with a stator ring 5. The stator ring 5 is provided with an inner circumference adapted to fit and encircle the back plate 3 (see also FIG. 2). The stator ring 5 has a surface which is essentially levelled with the back plate 3 such that air from the radial fan may flow smoothly from the back plate 3 to the stator ring 5. The surface of the stator ring 5 at its inner circumference is further designed to be parallel to the surface of the back plate 3. The stator ring 5 is preferably designed to make a close fit with the back plate and only separated by a gap necessary to allow the fan to rotate without any undesired contact between the stator ring 5 and the back plate 3.

In FIG. 3b is the air flow indicated in the same way as in FIG. 3a having white arrows indicating the desired flow and black arrows indicating recirculating flow. In order to indicate an improvement of the flow properties and reduced turbulence the black arrows have been made smaller thus indicating a reduced recirculation region in the air channel 301 in FIG. 3b compared to FIG. 3a.

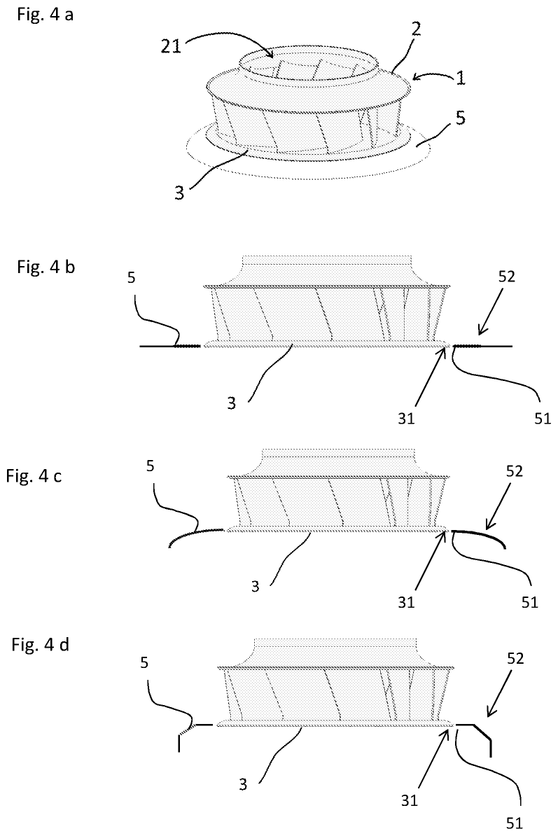

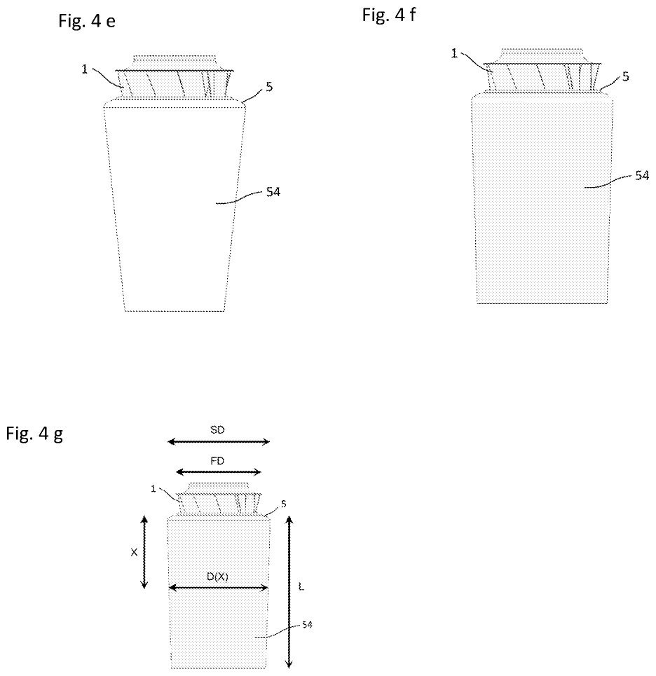

The design of the stator ring 5 in FIG. 3b could be somewhat different and further examples are disclosed in FIG. 4.

In FIG. 3c is disclosed a modification of the flow guiding arrangement in FIG. 3b. The stator ring 5 now forms part of a flow guiding body 54 which extends backwards in the axial direction from the radial fan 3. The flow guiding body 54 may be integrally constructed with the stator ring 5 or a separate feature designed to interact with the stator ring 5. The flow guiding body 54 preferably have a continuous surface along which the air flow may follow. The flow guiding body 54 may be solid or hollow. In FIG. 3c is the flow guiding body 54 designed such that it will have an envelope surface which is slightly angled relative the centre axle so as to form the shape of a truncated cone having its base upstream in the air flow direction and pointing along the axial direction of the fan 1.

In FIG. 3c the black arrows have been reduced further in size compared to the arrangement in FIG. 3b in order to visualize the further improvement of the flow pattern and a reduced recirculation regions in the air channel 301 by arranging a flow guiding body 54 cooperating with the stator ring 54.

The flow guiding body 54 disclosed in FIG. 3c could have other shapes than a truncated cone, e.g. as a half sphere, conical, tubular shaped or drop shaped. It may also be possible to design the stator ring to have other shapes and specific shapes of turbulence reducing bodies may be designed by computer aided simulations.

In FIG. 4a-4g are different embodiments of flow guiding arrangements disclosed.

In FIG. 4a is disclosed an isometric view of a radial fan 1 provided with stator ring 5. There is a small gap between the stator ring 5 and the back plate 3 of the fan 1 in order to allow the rotating back plate 3 to freely rotate without being in contact with the fixed stator disc 5.

FIGS. 4b-4d disclose different profiles of the stator disc 5 being located adjacent to the back plate 3. In FIG. 4b is the stator disc essentially flat while in FIG. 4c is the stator disc curved and bent backwards so as to induce a desired deflection of the air flow from the fan, i.e. to define a change of the air flow from being radial when leaving the fan to change to an axial flow. In FIG. 4d is an example having a stator disc 5 being bent instead of curved and a desired deflection of the air flow may be achieved by a stator disc having one or several bends instead of being continuously curved to form an overall structure being bent backwards.

In FIGS. 4e and 4f are disclosed different shapes of the flow guiding body wherein the flow guiding body 54 in FIG. 4 has the shape of truncated cone. Since the inclination of the walls of the flow guiding body 54 in this case is small the overall shape reminds of a tubular shape.

In FIG. 4f is disclosed a flow guiding body having a cylindrical shape.

FIG. 4g discloses different parameters which may be used for defining the design of the stator ring 5 and flow guiding body 54. In the figure is defined the width or diameter of the back plate which is referred to as FD and the width or diameter of the stator disc which is referred to as SD. In general, the diameter of the back plate is the same as the diameter of the fan 1. The flow guiding body 54 is further defined to have a length L. The flow guiding body 54 further has a width or diameter defined as D(x) which is the diameter or width at a distance X from the back plate 3.

In a specific embodiment of the invention, the flow guiding body 54 has a width or diameter D(x) at a distance X along the rotational axis of the fan 1 corresponding to at least half the length L of the body 54 which is larger than the diameter FD of the back plate. The width or diameter of the body 54 at a specific distance x from the back plate 3 should be measured in the body 54 in a cross sectional plane being a plane perpendicular to the rotational axis of the fan 1.

In summary, the disclosure relates to an air handling unit, AHU, 100 with an extract air channel 102 comprising at least one extract air inlet 102a for guiding extract air from a building to the outside through at least one extract air outlet 102b and/or a supply air channel 103 comprising at least one supply air inlet 103a for guiding supply air from the outdoor into a building through at least one supply air outlet 103b adapted to be connected to an air ventilation ducting system 101. Furthermore, the AHU 100 comprises at least one fan 1, 1a, 1b in order to induce a flow in the air ventilation ducting system 101 when connected. The fan 1, 1a, 1b has a front disc 2, a back plate 3 and a plurality of fan blades 4 located between the front disc 2 and the back plate 3. The front disc 2 has a hole 21 where through air enters and said fan blades 4 are arranged to provide a radial flow or mixed flow from the fan 1, 1a, 1b,

Furthermore, according to the disclosure, the fan 1, 1a, 1b comprises a stator ring 5 having an inner circumference 51 adapted to encircle the plate 3 and having a surface 52 which is essentially levelled with the surface at the edge 31 of the back plate 3.

According to a possible embodiment, the surface 52 of the stator ring 5 is bent backwards so as to provide a flow guide for the radial flow from the fan 1, 1a, 1b when the air flow deflects and changes direction from being a mainly radial flow to a mainly axial flow. This is shown in FIG. 4e, and also FIGS. 4c, 4d and 3c. This configuration of the stator ring 5, the back plate 3 and the flow guiding body 54 solves the above-mentioned problem. In particular, this will contribute to a reduced recirculation and turbulence in the air flow downstream of the fan. This will reduce the noise level as well as energy losses in the air handling unit 100.

As indicated in the drawings, FIG. 3c shows by means of arrows how the air flow is directed out from the fan 1 and along the flow guiding body 54 during operation of the air handling unit. In this case, a reduced recirculation and reduced noise will be obtained, as indicated with the circular, black arrows in FIG. 3c.

The above disclosed embodiments in FIGS. 3-5 are only intended to disclose a few embodiments of how a device according to the invention may be designed. The stator ring 5 and the flow guiding body 54 may thus be modified in different ways within the scope of the claims while fulfilling the inventive idea.

1. An Air Handling Unit, AHU, having an extract air channel comprising at least one extract air inlet for guiding extract air from a building to the outside through at least one extract air outlet and/or a supply air channel comprising at least one supply air inlet for guiding supply air from the outdoor into a building through at least one supply air outlet adapted to be connected to an air ventilation ducting system, said AHU further comprising at least one fan in order to induce a flow in the air ventilation ducting system when connected, said fan having a front disc, a back plate and a plurality of fan blades located between the front disc and the back plate, said front disc having a hole where through air enters and said fan blades being arranged to provide a radial flow or mixed flow from the fan,
wherein
said fan further comprising a stator ring having an inner circumference adapted to encircle said back plate and having a surface essentially levelled with the surface at the edge of the back plate.

2. The Air Handling Unit, AHU according to claim 1, wherein said surface of the stator ring being bent backwards so as to provide a flow guide for the radial flow from the fan when the air flow deflects and change direction from being a mainly radial flow to a mainly axial flow.

3. The Air Handling Unit, AHU according to claim 2, wherein said surface of the stator ring is bent at least 20 degrees between the stator ring's inner circumference and an outer circumference.

4. The Air Handling Unit, AHU according to claim 2, wherein said stator ring forms part of a flow guiding body extending backwards in the axial direction.

5. The Air Handling Unit, AHU according to claim 2, wherein said stator ring is designed to interact with a flow guiding body extending backwards in the axial direction and adapted to fit in with the outer edge of the stator ring to form a common flow guiding body.

6. The Air Handling Unit, AHU according to claim 4, wherein said stator ring and flow guiding body are designed to extend backwards in the radial direction at least a distance L corresponding to the radius of the back plate, said distance L measured from the back plate.

7. The Air Handling Unit, AHU according to claim 4, wherein said flow guiding body has a width of a cross sectional plane in a plane perpendicular to the rotational axis. at a length from the back plate corresponding to at least half the length of the extension of the flow guiding body along the rotational axis of the fan being larger than the diameter of the back plate.

8. The Air Handling Unit, AHU according to claim 4, wherein said stator ring and flow guiding body defines an essentially continuous surface enclosing a space stretching from the edge of the back plate and backwards in the axial direction.

9. The Air Handling Unit, AHU according to claim 7, wherein said flow guiding body has an outer surface shape that is a semi-spherical shape or truncated cone.

10. The Air Handling Unit, AHU according to claim 3, wherein said stator ring forms part of a flow guiding body extending backwards in the axial direction.

11. The Air Handling Unit, AHU according to claim 3, wherein said stator ring is designed to interact with a flow guiding body extending backwards in the axial direction and adapted to fit in with the outer edge of the stator ring to form a common flow guiding body.

12. The Air Handling Unit, AHU according to claim 4, wherein said stator ring is designed to interact with a flow guiding body extending backwards in the axial direction and adapted to fit in with the outer edge of the stator ring to form a common flow guiding body.

13. The Air Handling Unit, AHU according to claim 5, wherein said stator ring and flow guiding body are designed to extend backwards in the radial direction at least a distance L corresponding to the radius of the back plate, said distance L measured from the back plate.

14. The Air Handling Unit, AHU according to claim 5, wherein said flow guiding body has a width) of a cross sectional plane in a plane perpendicular to the rotational axis, at a length from the back plate corresponding to at least half the length of the extension of the flow guiding body along the rotational axis of the fan being larger than the diameter of the back plate.

15. The Air Handling Unit, AHU according to claim 6, wherein said flow guiding body has a width) of a cross sectional plane in a plane perpendicular to the rotational axis, at a length from the back plate corresponding to at least half the length of the extension of the flow guiding body along the rotational axis of the fan being larger than the diameter of the back plate.

16. The Air Handling Unit, AHU according to claim 5, wherein said stator ring and flow guiding body defines an essentially continuous surface enclosing a space stretching from the edge of the back plate and backwards in the axial direction.

17. The Air Handling Unit, AHU according to claim 6, wherein said stator ring and flow guiding body defines an essentially continuous surface enclosing a space stretching from the edge of the back plate and backwards in the axial direction.

18. The Air Handling Unit, AHU according to claim 10, wherein said stator ring is designed to interact with a flow guiding body extending backwards in the axial direction and adapted to fit in with the outer edge of the stator ring to form a common flow guiding body.

19. The Air Handling Unit, AHU according to claim 10, wherein said stator ring and flow guiding body are designed to extend backwards in the radial direction at least a distance L corresponding to the radius of the back plate, said distance L measured from the back plate.

20. The Air Handling Unit, AHU according to claim 11, wherein said stator ring and flow guiding body are designed to extend backwards in the radial direction at least a distance L corresponding to the radius of the back plate, said distance L measured from the back plate.
